(19) United States
(12) Patent Application Publication
(10) Pub. No.: US 2025/0162656 A1
(43) Pub. Date: May 22, 2025

(54) Crossbeam Stabilization in Vehicles

(71) Applicant: Nissan North America, Inc., Franklin, TN (US)

(72) Inventors: Brendan Gundy, Canton, MI (US); Sahil Jain, Sagamihara City (JP)

(21) Appl. No.: 18/515,042

(22) Filed: Nov. 20, 2023

(51) Int. Cl. B62D 25/14

(52) U.S. Cl. CPC B62D 25/145

(57) ABSTRACT

A vehicle that includes: a crossbeam; a coupler that is secured to the crossbeam; a front mounting member that is secured to the crossbeam; a steering column that is secured to the front mounting member; a steering wheel that is secured to the steering column; a reinforcing bracket that is positioned between the front mounting member and the steering column; and a stabilizing bracket that is positioned between the crossbeam and the coupler, wherein the reinforcing bracket and the stabilizing bracket are configured to inhibit deflection of the crossbeam and thereby reduce vibration through the steering wheel during operation of the vehicle.

### TECHNICAL FIELD

The present disclosure relates to the stabilization of a crossbeam in a vehicle. More specifically, the present disclosure describes various brackets that are configured to inhibit (e.g., reduce, prevent) deflection of the crossbeam and thereby inhibit (e.g., reduce, prevent) vibration through the steering wheel during operation of the vehicle.

### BACKGROUND

Vehicles typically include a crossbeam, which is also sometimes referred to as a steering member, that extends along (e.g., in generally parallel relation to) a width of the vehicle. Among other functions, the crossbeam supports various components in the cockpit of the vehicle (e.g., the steering column, the dashboard, the instrument panel, the GPS module, the air bag(s), various wiring harnesses, etc.), increases the overall stiffness of the vehicle, and assists in managing side impact loads. An opportunity remains, however, to increase the stability of the crossbeams in vehicles in order to inhibit (e.g., reduce, prevent) deflection thereof and thereby inhibit (e.g., reduce, prevent) vibration through the steering column and the steering wheel, which is address by the present disclosure.

### SUMMARY

In one aspect of the present disclosure, a vehicle is disclosed that includes: a crossbeam; a coupler that is secured to the crossbeam; a front mounting member that is secured to the crossbeam; a steering column that is secured to the front mounting member; a steering wheel that is secured to the steering column; a reinforcing bracket that is positioned between the front mounting member and the steering column; and a stabilizing bracket that is positioned between the crossbeam and the coupler, wherein the reinforcing bracket and the stabilizing bracket are configured to inhibit deflection of the crossbeam and thereby reduce vibration through the steering wheel during operation of the vehicle. The crossbeam extends along a width of the vehicle and includes a first section and a second section that is secured to the first section at an interface. The coupler is secured to the crossbeam at the interface such that the coupler extends from the crossbeam along a height of the vehicle.

In certain embodiments, the reinforcing bracket may nest within the front mounting member.

In certain embodiments, the reinforcing bracket may define an outer contour corresponding to an inner contour that is defined by the front mounting member.

In certain embodiments, the reinforcing bracket may be directly secured to the crossbeam and the front mounting member.

In certain embodiments, the reinforcing bracket may be welded to the crossbeam and the front mounting member.

In certain embodiments, the stabilizing bracket may include a body that defines an outer contour corresponding to an outer contour defined by the crossbeam and a mounting flange that extends laterally outward from the body along a length of the vehicle.

In certain embodiments, the outer contour defined by the body may include an arcuate recess that is configured to receive the crossbeam.

In certain embodiments, the mounting flange may include a notch that is configured to receive the coupler.

In certain embodiments, the stabilizing bracket may be directly secured to the crossbeam and the coupler.

In certain embodiments, the stabilizing bracket may be welded to the crossbeam and the coupler.

In another aspect of the present disclosure, a vehicle is disclosed that includes: a crossbeam, which extends along a width of the vehicle; a front mounting member that is secured to the crossbeam; a steering column that is secured to the front mounting member; and a reinforcing bracket that is secured to the crossbeam and the front mounting member to inhibit deformation of the front mounting member and deflection of the crossbeam to thereby reduce vibration through the steering column, wherein the reinforcing bracket is positioned vertically between the front mounting member and the steering column along a height of the vehicle.

In certain embodiments, the reinforcing bracket may be unitary in construction.

In certain embodiments, the reinforcing bracket may nest within the front mounting member.

In certain embodiments, the reinforcing bracket may include an outer wall that is configured in correspondence with an inner wall of the front mounting member.

In certain embodiments, the reinforcing bracket may include at least one locating feature to facilitate proper alignment of the reinforcing bracket and the front mounting member.

In another aspect of the present disclosure, a vehicle is disclosed that includes: a crossbeam, which extends along a width of the vehicle; a coupler that is secured to the crossbeam; a steering column that is secured to the crossbeam; and a stabilizing bracket that is secured to the crossbeam and the coupler, wherein the stabilizing bracket is configured to inhibit deflection of the crossbeam and thereby reduce vibration through the steering column. The crossbeam includes a first section and a second section that is secured to the first section at an interface. The coupler is secured to the crossbeam at the interface such that the coupler extends from the crossbeam along a height of the vehicle.

In certain embodiments, the stabilizing bracket may include a body and a mounting flange that extends laterally outward from the body along a length of the vehicle.

In certain embodiments, the body may be welded to the crossbeam and the coupler.

In certain embodiments, the mounting flange may be welded to the coupler.

In certain embodiments, the body may define an arcuate recess that is configured to receive the crossbeam.

In certain embodiments, the mounting flange may include a notch that is configured to receive the coupler such that, upon assembly of the vehicle, the coupler extends into the stabilizing bracket.

### BRIEF DESCRIPTION OF THE DRAWINGS

According to common practice, the various features of the drawings may not be to scale and may be arbitrarily expanded or reduced for clarity.

FIG. 1 is a partial, top perspective view of a vehicle that includes: a crossbeam; a coupler; a front mounting member; a reinforcing bracket; and a stabilizing bracket.

FIG. 2 is a top, perspective view of the crossbeam, the coupler, the front mounting member, and the stabilizing bracket shown with a steering column of the vehicle.

FIG. 3 is a bottom, plan view of the crossbeam, the front mounting member, the steering column, and the reinforcing bracket.

FIG. 4 is a partial, bottom, perspective view of the crossbeam, the front mounting member, and the reinforcing bracket.

FIG. 5 is a partial, top, perspective view illustrating connection of the front mounting member, the crossbeam, and the reinforcing bracket.

FIG. 6 is a partial, bottom, perspective view illustrating connection of the crossbeam and the coupler.

FIG. 7 is a partial, top, perspective view of the crossbeam, the coupler, and the stabilizing bracket shown separated.

FIG. 8 is a partial, bottom, perspective view illustrating connection of the crossbeam, the coupler, and the stabilizing bracket.

FIG. 9 is a partial, side, plan view illustrating connection of the coupler and the stabilizing bracket.

### DETAILED DESCRIPTION

The present disclosure describes a vehicle including various brackets that are configured to inhibit (e.g., reduce, prevent) the deflection of the crossbeam and thereby inhibit (e.g., reduce, prevent) vibration through the steering wheel during operation of the vehicle. More specifically, the vehicle described herein includes: a coupler and a front mounting member, each of which is secured to the crossbeam; a steering column that is secured to the front mounting member; a reinforcing bracket that is secured to the crossbeam and the front mounting member; and a stabilizing bracket that is secured to the crossbeam and the coupler.

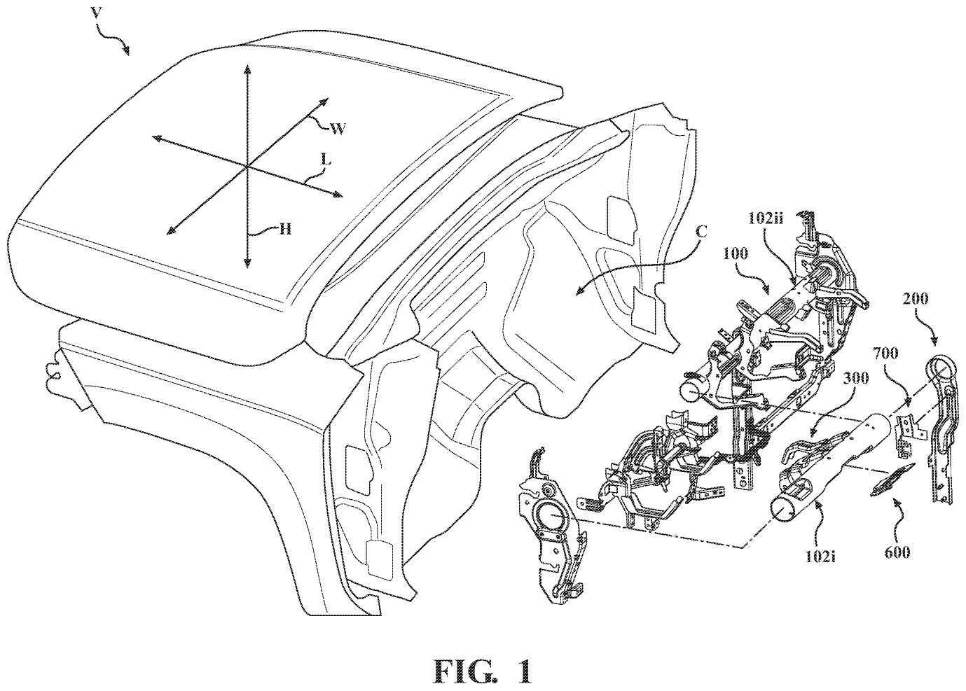

With reference to FIGS. 1-3, a vehicle Vis disclosed that includes: a crossbeam 100; a coupler 200; a front mounting member 300; a steering column 400; a steering wheel 500, which is secured (connected) to the steering column 400; a reinforcing (first) bracket 600; and a stabilizing (second) bracket 700. Although generally illustrated and described in the context of a passenger vehicle, it should be appreciated that the various components described herein may be configured for use with a wide variety of vehicles (e.g., trucks, SUVs, vans, buses, etc.).

As indicated above, the crossbeam 100 extends along (e.g., in generally parallel relation to) a width W (FIG. 1) of the vehicle V and not only supports various components in a cockpit C thereof, but increases the overall stiffness of the vehicle V, and assists in managing side impact loads.

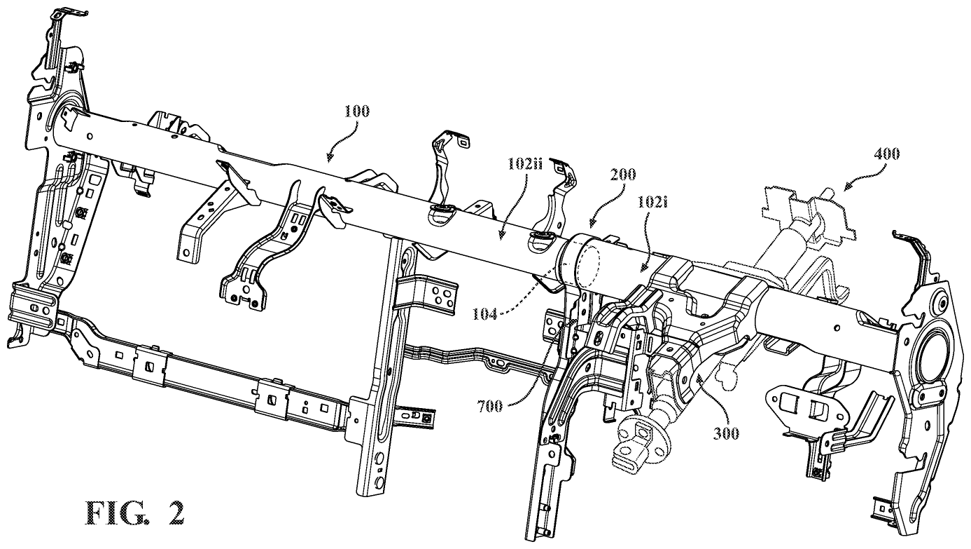

The crossbeam 100 includes a (first, driver side) section 102i and a (second, passenger side) section 102ii that is secured (connected) to the section 102i at an interface 104 (FIG. 2), which is defined by an overlapping region of the sections 102i, 102ii. In the illustrated embodiment, the sections 102i, 102ii are fixed (i.e., non-movable) in relation to each other. Embodiments in which the sections 102i, 102ii may be configured for relative (e.g., telescopic) movement are also envisioned herein, however, and would not be beyond the scope of the present disclosure.

The coupler 200 is secured (connected) to the crossbeam 100 such that the coupler 200 spans the interface 104. More specifically, in the illustrated embodiment, the coupler 200 is welded to the sections 102i, 102ii of the crossbeam 100. As seen in FIG. 1, the coupler 200 extends from the crossbeam 100 along (e.g., in generally parallel relation to) a height H (FIG. 1) of the vehicle V in a generally vertical orientation.

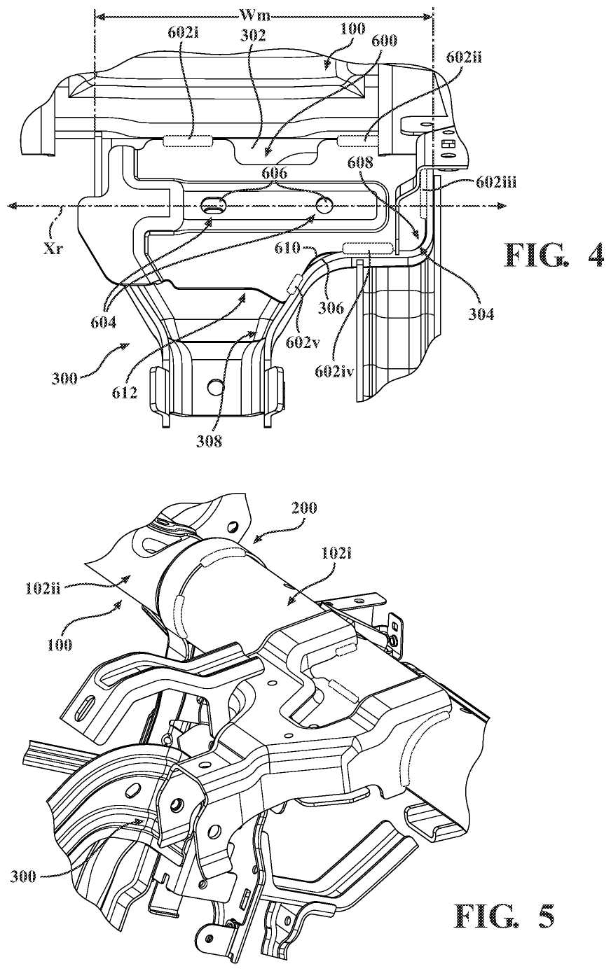

With reference to FIGS. 4 and 5 as well, the front mounting member 300 is (directly) secured (connected) to the crossbeam 100 and extends between the crossbeam 100 and the steering column 400. As seen in FIG. 4, the front mounting member 300 includes a chamber 302 that is configured to receives the reinforcing bracket 600, as described in further detail below.

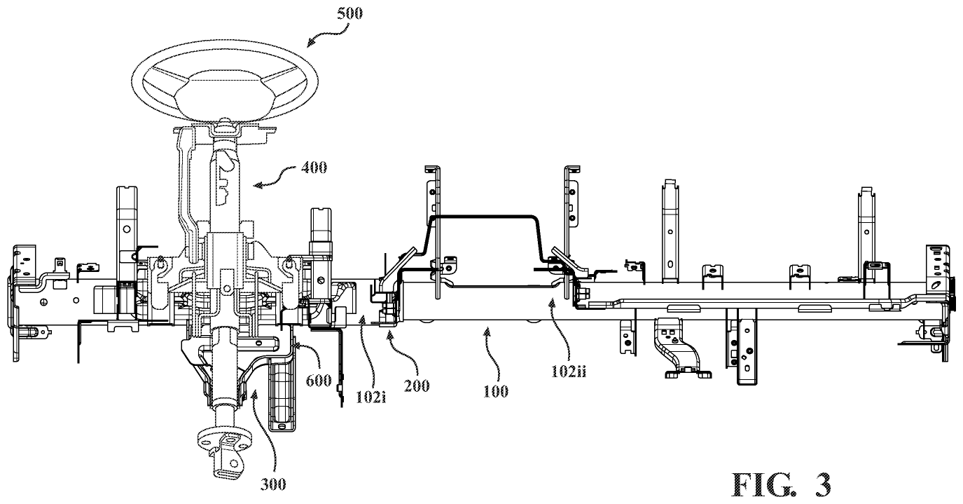

As indicated above, the steering column 400 (FIGS. 2, 3) is secured (connected) to the steering wheel 500, whereby torque is transferred from the steering wheel 500 to the wheels of the vehicle V through the steering column 400. The steering column 400 extends through the front mounting member 300 and is (directly) secured (connected) thereto, whereby the steering column 400 is (indirectly) secured (connected) to the crossbeam 100 via the front mounting member 300.

The reinforcing bracket 600 increases the strength (e.g., the rigidity) of the front mounting member 300 in order to inhibit (e.g., reduce, prevent) deformation (e.g., bending, twisting, and/or flexure) thereof during operation of the vehicle V. Inhibiting deformation of the front mounting member 300 stabilizes the crossbeam 100 and inhibits (e.g., reduces, prevents) deflection thereof (e.g., vertical movement along the height H of the vehicle V), thereby reducing the resonance frequency of the crossbeam 100 and, thus, vibration (and/or noise) through the steering column 400 and the steering wheel 500.

As seen in FIG. 3, the reinforcing bracket 600 is positioned vertically between the front mounting member 300 and the steering column 400 along the height H of the vehicle V in a generally horizontal orientation (i.e., such that the reinforcing bracket 600 defines a longitudinal axis Xr (FIG. 4) that extends in generally parallel relation to the width W (FIG. 1) of the vehicle V). More specifically, the reinforcing bracket 600 is positioned within the chamber 302 defined by the front mounting member 300 such that the reinforcing bracket 600 nests (partially or entirely) within the front mounting member 300.

The reinforcing bracket 600 is (directly) secured (connected) to the crossbeam 100 and the front mounting member 300. More specifically, in the illustrated embodiment, the reinforcing bracket 600 is welded to the crossbeam 100 at (two) weld points 602i, 602ii (FIG. 4) and to the front mounting member 300 at (three) weld points 602iii, 602iv, 602v. Embodiments in which the number of weld points 602 may be increased or decreased are also envisioned herein (e.g., depending upon the particular configurations of the crossbeam 100, the front mounting member 300, and/or the reinforcing bracket 600), however, and would not be beyond the scope of the present disclosure. Welding of the reinforcing bracket 600 to the crossbeam 100 and the front mounting member 300 eliminates the need for mechanical fasteners, which not only simplifies assembly of the vehicle V but increases the strength (e.g., the rigidity) of the front mounting member 300 as well as the strength of the connection of the reinforcing bracket 600 to the crossbeam 100 and the front mounting member 300.

In order to facilitate manufacturing of the reinforcing bracket 600 and/or proper registration (alignment, orientation) of the reinforcing bracket 600 and the front mounting member 300, the reinforcing bracket 600 includes (one or more) at least one locating feature 604. Although shown as including a pair of openings 606, it should be appreciated that the specific configuration of the locating feature(s) 604 may be varied in alternate embodiments (e.g., depending upon the specific configurations of the front mounting member 300 and/or the reinforcing bracket 600). For example, an embodiment in which the locating feature(s) 604 may include alignment pin(s) is also envisioned herein and would not be beyond the scope of the present disclosure.

The reinforcing bracket 600 is unitary (e.g., monolithic) in construction (i.e., such that the reinforcing bracket 600 is formed from a single piece of material) and includes a generally plate-like configuration. The reinforcing bracket 600 defines an outer contour 608 (FIG. 4) that mirrors an inner contour 304 defined by the front mounting member 300 (e.g., the chamber 302). More specifically, the reinforcing bracket 600 includes an outer wall 610, which defines an outer perimeter 612 thereof, that is configured in correspondence with an inner wall 306 defined by the front mounting member 300, which defines an inner perimeter 308 of the chamber 302.

As seen in FIG. 4, the reinforcing bracket 600 spans a width Wm of the front mounting member 300, which extends in generally parallel relation to the width W (FIG. 1) of the vehicle V, such that the outer wall 610 of the reinforcing bracket 600 contacts (engages) the inner wall 306 of the front mounting member 300. Contact (engagement) of the outer wall 610 and the inner wall 306 increases the surface area in contact between the reinforcing bracket 600 and the front mounting member 300, which further increases the strength of the front mounting member 300. In the illustrated embodiment, the reinforcing bracket 600 and the front mounting member 300 are configured such that approximately 35% to approximately 65% of the outer perimeter 612 of the reinforcing bracket 600 is in contact (engagement) with the inner perimeter 308 of the chamber 302. It should be appreciated, however, that the configurations of the reinforcing bracket 600 and the front mounting member 300 may be altered in various embodiments to increase or decrease the surface area in contact between the reinforcing bracket 600 and the front mounting member 300.

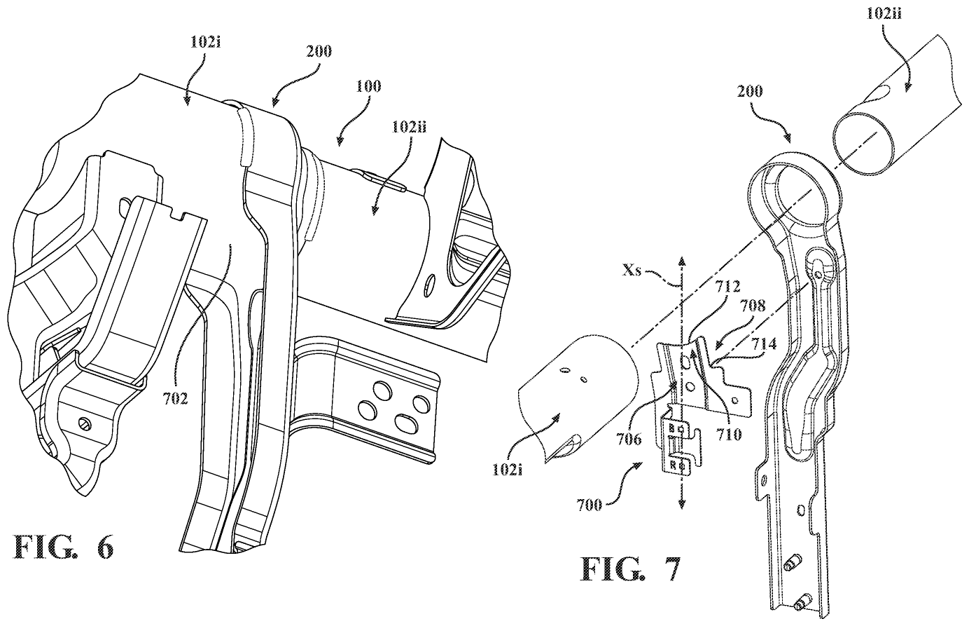

Referring now to FIGS. 6-9 as well, the stabilizing bracket 700 will be discussed. Like the reinforcing bracket 600, the stabilizing bracket 700 stabilizes the crossbeam 100 and inhibits (e.g., reduces, prevents) deflection thereof (e.g., vertical movement along the height H of the vehicle V), thereby reducing the resonance frequency of the crossbeam 100 and, thus, vibration (and/or noise) through the steering column 400 and the steering wheel 500, as discussed above.

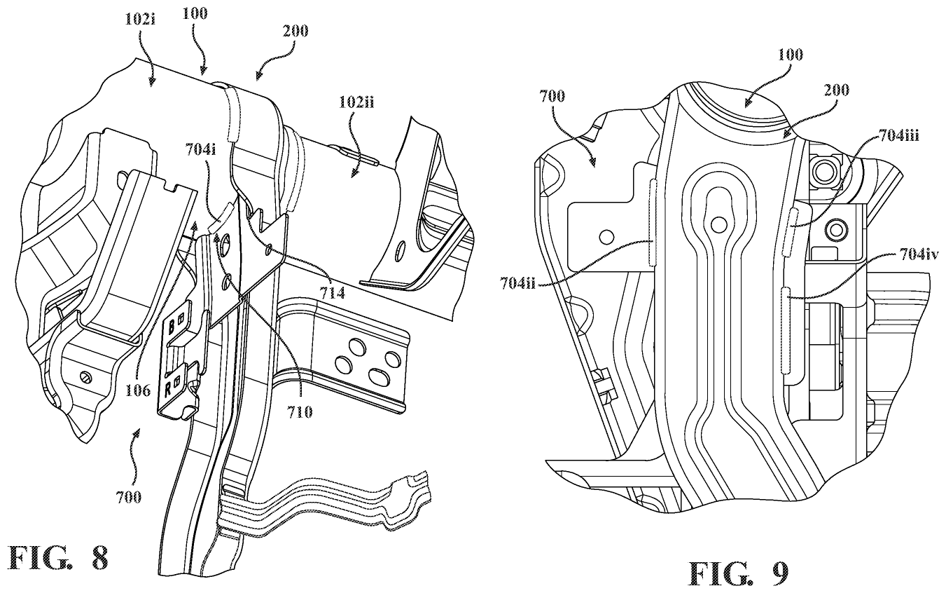

The stabilizing bracket 700 is positioned between and is (directly) secured (connected) to the crossbeam 100 and the coupler 200 and is configured to reduce (if not entirely eliminate) gapping therebetween. More specifically, the stabilizing bracket 700 is configured to occupy (fill) a gap (space) 702 (FIG. 6) that is defined between the crossbeam 100 and the coupler 200 (i.e., absent the stabilizing bracket 700), which increases the strength of the connection between the crossbeam 100 and the coupler 200. As seen in FIGS. 7 and 8, upon connection to the crossbeam 100 and the coupler 200, the stabilizing bracket 700 is oriented in a generally vertical orientation such that the stabilizing bracket 700 defines a longitudinal axis Xs (FIG. 7) that extends in generally parallel relation to the height H (FIG. 1) of the vehicle V.

In the illustrated embodiment, the stabilizing bracket 700 is welded to both the crossbeam 100 and the coupler 200, thereby eliminating the need for mechanical fasteners, which not only simplifies assembly of the vehicle V, but increases the strength of the connection of the stabilizing bracket 700 to the crossbeam 100 and the coupler 200. More specifically, the stabilizing bracket 700 is welded to the crossbeam 100 at a (single) weld point 704i (FIG. 8) and to the coupler 200 at (three) weld points 704ii, 704iii, 704iv (FIG. 9). Embodiments in which the number of weld points 704 may be increased or decreased are also envisioned herein (e.g., depending upon the particular configurations of the crossbeam 100, the coupler 200, and/or the stabilizing bracket 700), however, and would not be beyond the scope of the present disclosure.

The stabilizing bracket 700 is unitary (e.g., monolithic) in construction (i.e., such that the stabilizing bracket 700 is formed from a single piece of material) and includes a body 706 (FIG. 7) and a mounting flange 708.

The body 706 defines an outer contour 710 corresponding to (mirroring) an outer contour 106 (FIG. 8) defined by the crossbeam 100. More specifically, the body 706 includes an arcuate recess 712 (FIG. 7) that is configured to receive the crossbeam 100 such that the crossbeam 100 nests within the stabilizing bracket 700.

The mounting flange 708 extends laterally outward from the body 706 along (e.g., in generally parallel relation to) a length L (FIG. 1) of the vehicle V. The mounting flange 708 includes a notch 714 that is configured to receive the coupler 200 such that, upon assembly of the vehicle V, the coupler 200 extends into the stabilizing bracket 700 via the notch 714.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (i.e., an angle that lies within the range of (approximately) 135° to (approximately)) 225° and the term “generally orthogonal” should be understood as referring to configurations in with the pertinent components are oriented so as to define an angle therebetween that is equal to 90°+25% (i.e., an angle that lies within the range of (approximately) 67.5° to (approximately)) 112.5°. The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a crossbeam extending along a width of the vehicle, wherein the crossbeam includes:
a first section; and
a second section secured to the first section at an interface;
a coupler secured to the crossbeam at the interface such that the coupler extends from the crossbeam along a height of the vehicle;
a front mounting member secured to the crossbeam;
a steering column secured to the front mounting member;
a steering wheel secured to the steering column;
a reinforcing bracket positioned between the front mounting member and the steering column; and
a stabilizing bracket positioned between the crossbeam and the coupler, wherein the reinforcing bracket and the stabilizing bracket are configured to inhibit deflection of the crossbeam and thereby reduce vibration through the steering wheel during operation of the vehicle.

2. The vehicle of claim 1, wherein the reinforcing bracket nests within the front mounting member.

3. The vehicle of claim 2, wherein the reinforcing bracket defines an outer contour corresponding to an inner contour defined by the front mounting member.

4. The vehicle of claim 1, wherein the reinforcing bracket is directly secured to the crossbeam and the front mounting member.

5. The vehicle of claim 4, wherein the reinforcing bracket is welded to the crossbeam and the front mounting member.

6. The vehicle of claim 1, wherein the stabilizing bracket includes:
a body defining an outer contour corresponding to an outer contour defined by the crossbeam; and
a mounting flange extending laterally outward from the body along a length of the vehicle.

7. The vehicle of claim 6, wherein the outer contour defined by the body includes an arcuate recess configured to receive the crossbeam.

8. The vehicle of claim 7, wherein the mounting flange includes a notch configured to receive the coupler.

9. The vehicle of claim 1, wherein the stabilizing bracket is directly secured to the crossbeam and the coupler.

10. The vehicle of claim 9, wherein the stabilizing bracket is welded to the crossbeam and the coupler.

11. A vehicle comprising:
a crossbeam extending along a width of the vehicle;
a front mounting member secured to the crossbeam;
a steering column secured to the front mounting member; and
a reinforcing bracket secured to the crossbeam and the front mounting member to inhibit deformation of the front mounting member and deflection of the crossbeam to thereby reduce vibration through the steering column, wherein the reinforcing bracket is positioned vertically between the front mounting member and the steering column along a height of the vehicle.

12. The vehicle of claim 11, wherein the reinforcing bracket is unitary in construction.

13. The vehicle of claim 11, wherein the reinforcing bracket nests within the front mounting member.

14. The vehicle of claim 13, wherein the reinforcing bracket includes an outer wall configured in correspondence with an inner wall of the front mounting member.

15. The vehicle of claim 11, wherein the reinforcing bracket includes at least one locating feature to facilitate proper alignment of the reinforcing bracket and the front mounting member.

16. A vehicle comprising:
a crossbeam extending along a width of the vehicle, wherein the crossbeam includes:
a first section; and
a second section secured to the first section at an interface;
a coupler secured to the crossbeam at the interface such that the coupler extends from the crossbeam along a height of the vehicle;
a steering column secured to the crossbeam; and
a stabilizing bracket secured to the crossbeam and the coupler, wherein the stabilizing bracket is configured to inhibit deflection of the crossbeam and thereby reduce vibration through the steering column.

17. The vehicle of claim 16, wherein the stabilizing bracket includes:
a body; and
a mounting flange extending laterally outward from the body along a length of the vehicle.

18. The vehicle of claim 17, wherein the body is welded to the crossbeam and the coupler, and the mounting flange is welded to the coupler.

19. The vehicle of claim 17, wherein the body defines an arcuate recess configured to receive the crossbeam.

20. The vehicle of claim 19, wherein the mounting flange includes a notch configured to receive the coupler such that, upon assembly of the vehicle, the coupler extends into the stabilizing bracket.
